(19) United States
(12) Patent Application Publication
(10) Pub. No.: US 2026/0208712 A1
(43) Pub. Date: Jul. 23, 2026

(54) FAIL-SAFE BRAKING SYSTEM

(71) Applicant: Heinz LEIBER, Oberriexingen (DE)

(72) Inventor: Heinz LEIBER, Oberriexingen (DE)

(21) Appl. No.: 19/375,790

(22) Filed: Oct. 31, 2025

Related U.S. Application Data
(63) Continuation of application No. PCT/EP2024/061927, filed on Apr. 30, 2024.

(30) Foreign Application Priority Data
May 3, 2023 (DE) 10 2023 111 489.1

(51) Int. Cl. B60T 8/88; B60T 8/40; B60T 13/74

(52) U.S. Cl. CPC B60T 8/885; B60T 8/4081; B60T 13/745

(57) ABSTRACT

A braking system includes at least two wheel brake cylinders each included in separate wheel circuits, at least one electrically driven pressure supply to provide pressure build-up and pressure reduction in the wheel brake cylinders, at least one reservoir, at least one electronic control and regulation device, and at least two switching valves. Each of the wheel brake cylinders is connected via a hydraulic connecting line to a switching valve to disconnect and connect a hydraulic connection of the respective wheel brake cylinder and at least one further hydraulic main line, via which the switching valve is connectable to the pressure supply, and the switch valves are de-energized open 2/2-way valves. At least one or all switching valves have no check valve or no check valve connected in parallel to a switching valve, and the switching value is prevented from closing when the pressure is reduced via the switching valve.

### CROSS REFERENCE TO RELATED APPLICATIONS

This application claims the benefit of priority to German Patent Application No. 10 2023 111 489.1 filed on May 3, 2023 and is a Continuation Application of PCT Application No. PCT/EP 2024/061927 filed on Apr. 30, 2024. The entire contents of each application are hereby incorporated herein by reference.

### BACKGROUND OF THE INVENTION

### 1. Field of the Invention

For almost 80 years, the current dual-circuit braking system with two brake circuits has been the standard for safety reasons and, depending on the vehicle design, is divided into a brake circuit layout (a) diagonally and (b) black/white or front axle/rear axle.

### 2. Description of the Related Art

In the event of a brake circuit failure, the braking effect is reduced by 50% in (a) and by up to approximately 70% in (b), described above. Statistics estimate a brake circuit failure rate of 10 ppm/year. The reduced braking effect or total brake failure poses a considerable risk of accidents.

DE 10 20 2018 213 306 describes a system that detects brake circuit failure due to leakage in the brake circuit by evaluating the pressure gradient.

Almost all vehicles have electronic brake control systems for all four wheels, which are usually hydraulically braked. Each wheel brake cylinder is connected to at least one or two electromagnetically controlled control valves, which are electrically controlled by an electronic control unit (ECU) to prevent the wheel from locking, for example.

In today's standard braking systems with ABS/ESP function, each wheel brake cylinder is usually assigned an inlet and an outlet valve, whereby the inlet valve usually has a parallel-connected check valve to prevent the inlet valve from closing due to dynamic pressure during rapid pressure reduction.

If an inlet valve with its associated check valve fails and leaks, in today's dual-circuit braking systems, failure of the wheel brake cylinder usually causes an entire brake circuit to fail, reducing the braking effect by at least 30%.

In many of today's braking systems, the failure of the wheel brake cylinder is detected via diagnostics and the associated inlet valve is closed. However, if the check valve, which is connected in parallel to the inlet valve, leaks, the entire brake circuit fails. This measure is therefore considered an improvement, but is not considered fail-safe because the check valve cannot be diagnosed before every braking maneuver during normal driving. When the pressure is reduced, or, for example, when the hydraulic fluid flows toward the opening of the check valve due to temperature changes, a particle can be washed in despite the filter, causing the check valve to leak when the pressure builds up. This means that if a wheel cylinder fails, the inlet valve loses its function as a safety element.

### SUMMARY OF THE INVENTION

Example embodiments of the present invention provide highly fail-safe braking systems requiring fewer valves.

Example embodiments of the present invention include components that are as fail-safe as possible and/or include appropriate safety valves, in particular, in the form of shut-off valves between a pressure supply and wheel brake cylinders and/or between wheel circuits or brake circuits.

An inlet valve commonly used for ABS/ESP has a parallel check valve, which is considered unreliable in terms of tightness and can therefore no longer be used when high reliability requirements apply. As described above, the check valve was provided so that the inlet valve does not close due to back pressure when the pressure is reduced quickly.

It is therefore advantageous to use a switching valve instead of an inlet valve with a parallel check valve a switching valve is used which is designed to close reliably in at least one flow direction, even at high flow velocities or high pressure gradients, or the braking system is designed and/or its controllable and/or adjustable components are operated in such a way that the switching valve is prevented from closing even at high flow velocities.

To prevent a switching valve from closing when pressure is reduced via the switching valve, the following measures may be provided, either alone or in combination.
a) The valve actuator of the switch valve can be acted upon by a restoring force in its open position which is at least 30-50% greater than that of standard inlet valves in ABS systems, whereby the increased restoring force is generated by a stronger restoring spring and/or by a magnetic force that acts in addition to the force of the restoring spring, whereby the additional magnetic force can be generated, for example, by at least one permanent magnet or an electromagnet.
b) The pressure reduction speed is adjusted or regulated, in particular limited, by an electrically driven pressure supply in such a way that closing of the switching valve is avoided.
c) A parallel connection including a throttle and a check valve is arranged in the hydraulic connection line connecting the pressure supply to the switching valves, whereby the check valve blocks in the direction of the pressure supply. The throttle advantageously limits the volume flow and thus prevents the switching valve from closing when the pressure is reduced. Pressure can build up unhindered via the check valve connected in parallel to the throttle.
d) The isolating valve, which is configured to connect or disconnect the wheel circuits to and from a master brake cylinder, has a flow cross-section which is dimensioned such that, in the event of a pressure drop in a wheel circuit, the switch valve is prevented from closing via the isolation valve.
e) The isolating valve, which is configured to connect or disconnect the wheel circuits to and from a master brake cylinder and via which the pressure reduction in a wheel circuit takes place, is opened and closed in pulse width mode in order to limit the flow rate or flow velocity to a level such that the switching valve is prevented from sticking.
f) The drive of the pressure supply (DV) is a multiphase motor whose electrical connection of the windings is designed in such a way that, in the event of a failure of the motor control and/or the electrical control unit (ECU) of the braking system, the electric motor is operated in generator mode and, due to the winding connection, the electric motor acts as a brake for the piston of the pressure supply (DV) and thus limits slows down the pressure reduction rate (dp_{ab}/dt).

Measures b) to f) thus also reliably prevent the closing of a conventional inlet valve with or without a check valve.

It is advantageous if the switching valve used in accordance with an example embodiment of the present invention, which is assigned to each wheel brake cylinder, is designed to be as fail-safe as possible, so that in principle no further valves, in particular shut-off valves, are required to decouple a wheel circuit or brake circuit that has become leaky. If, however, safety is to be increased, at least one of the shut-off valves described above can be provided additionally.

To increase reliability and braking effect in the event of a fault, it is also advantageous to use switching valves for the wheel brake cylinders in which the electromagnetic drive or at least some of its components are provided or designed redundantly, i.e., at least twice.

For example, the switching valve may include at least two coils and two coil controls, which can switch the switching valve separately from each other, so that if one coil or its control fails, the other can take over its function, making the switching valve significantly more fail-safe and thus also making the entire braking system more fail-safe.

The coils can also be designed so that they can each switch the valve safely up to a certain pressure of, for example, 100 bar, and that higher pressures can only be switched by the joint energization or control of both coils.

A switching valve according to an example embodiment of the present invention is understood to be the valve assigned to a wheel brake cylinder, through which hydraulic fluid flows to build up pressure in only this wheel brake cylinder. The wheel circuit is then understood here to be the wheel brake cylinder including the hydraulic connection from the switching valve to the wheel brake cylinder. An example embodiment of the present invention provides that, in order to reduce pressure in a wheel brake cylinder, a hydraulic fluid is fed from the associated wheel brake cylinder into the brake circuit via the switch valve. The switch valve can be a conventional inlet valve for existing ABS systems, which does not have a check valve. According to an example embodiment of the present invention, this can also be modified in such a way that, for example, additional magnetic force or a stronger spring makes it more difficult to close the valve. An outlet valve assigned to a wheel brake cylinder is also part of the respective wheel circuit, if provided.

To avoid the problems described above, a switch valve of the “normally open” type described above can be used for a braking system according to an example embodiment of the present invention. Its valve actuator is moved by a first electromagnetic drive from the open valve position to the closed valve position, in which the valve actuator is pressed against a valve seat and adjusted. The closing function and, if applicable, the sticking of the switching valve SVi can be detected by a diagnostic or diagnostic circuit.

A SVi switching valve according to an example embodiment of the present invention is the safety gate for the BK brake circuits to the RZ wheel brake cylinder. If, in the braking system according to an example embodiment of the present invention, one of the four hydraulic connections from the hydraulic control unit to a wheel brake cylinder fails, or if the wheel brake cylinder leaks, a switch valve according to an example embodiment of the present invention can be used to disconnect the faulty hydraulic connection or the faulty wheel brake cylinder from the rest of the braking system with a high degree of reliability.

In principle, the additional measures to prevent the switch valve from closing only need to be activated or take effect when a rapid pressure reduction in one flow direction via the switch valve is required. In all other operating states of the braking system, the measures or the additional holding or support force generated, for example, by permanent magnets, an additional coil, or an additional force device are not necessary, so that energy can be saved advantageously. This also allows the PWM method used worldwide for fine-tuning the pressure build-up to be retained.

If a wheel circuit actually fails in a braking system according to an example embodiment of the present invention, only the braking effect of this one failed wheel circuit is lost, while the braking effect of the remaining three wheel circuits remains available. This results in only a reduction in braking effect from four to three intact wheel circuits, so that in the event of a wheel circuit failure on the front axle, only approximately 35% loss of braking effect is recorded, in contrast to 70% as described above for a black/white brake circuit distribution, where an entire brake circuit and thus two wheel circuits always fail.

A braking system according to an example embodiment of the present invention generally includes four wheel circuits, in which either two wheel circuits are assigned to one brake circuit or three wheel circuits are assigned to a first brake circuit and a fourth wheel circuit forms its own brake circuit. If one wheel circuit fails, the three remaining wheel circuits are advantageously still available for braking.

The functional reliability of a braking system according to an example embodiment of the present invention can be further increased in the event of dirt particles in the brake fluid by installing at least filter with a small mesh size at the inlet and/or outlet of the valve. The mesh size should be selected so small that these small dirt particles, when the switch valve is closed, only cause minor leaks and thus only minor flow rates, which can be compensated for by the pressure supply, but which can be detected by the diagnosis both via the delivery rate of the pressure supply and via the level in the reservoir.

In order to check the function of a switching valve according to an example embodiment of the present invention, a measurement of the volume intake and the time curve of the pressure in the respective wheel circuit and a comparison with the previously determined pressure-volume characteristic curve of the wheel circuit can be carried out during diagnosis, for example. The diagnosis can be carried out during each braking operation and/or also at a standstill or during servicing.

As described above, the preferred switching valve does not require a check valve and still meets a wide range of requirements. The switching valve is to remain open securely in both directions, at least at high flow rates during pressure build-up, i.e., the typical weak point of today's valves, whereby at high flow rates, effects at the valve seat exert a force on the valve actuator, usually in the form of a valve ball with valve cone, and the valve spring, causing the valve to close automatically, must not occur.

The switching valve can be optimized by designing the sealing cone, the dimensions of the return spring, and the valve tappet appropriately, in addition to the force-adding device. In the closed position of the valve, which can also be used to reduce the pressure in the wheel brake cylinder, the push-up force should be significantly lower than when using a progressive spring, which has a higher force in this position than in the open position, which is unfavorable for the dimensioning of the solenoid circuit due to the correspondingly higher force requirement.

A braking system according to an example embodiment of the present invention can include various valve circuits described in the following:
a) Four switching valves for four wheel brake cylinders each, via which both the pressure build-up and the pressure reduction for the respective assigned wheel brake cylinders take place;
b) four switching valves for four wheel brake cylinders each, as well as two outlet valves;
c) four switching valves and four outlet valves.

When using an outlet valve for a wheel circuit, it is possible to control the pressure build-up Pup and pressure reduction Pdown individually for each wheel. If a leak occurs in a wheel circuit, a diagnostic circuit can identify the faulty wheel circuit during both braking and parking and close the switch valve belonging to the wheel circuit, so that in the event of this single fault, three wheel circuits remain available, and in the event of a double fault, i.e., if two wheel circuits fail simultaneously, two wheel circuits remain available in the worst case. In conventional braking systems, on the other hand, a total brake failure occurs in the worst case.

In summary, it can therefore be stated that minor changes to the inlet valve and the elimination of the check valve with the switch valve can advantageously achieve a high gain in safety. With an appropriate design of the switch valve, a reduction in costs is possible in addition to the gain in safety.

A braking system according to an example embodiment of the present invention can also be designed in such a way that, instead of four hydraulic wheel circuits, a mixed hydraulic-electric braking system is provided with, for example, hydraulic lines to the hydraulically operated front brakes and only electrical connections to the electromotive brakes (EMB) on the rear axle, the structure of which is known. Here, too, the same advantages result if the hydraulic wheel circuits are designed in accordance with the above-described example embodiments.

With the additional use of a circuit isolating valve between the two brake circuits or additional circuit isolating valves between the brake circuit and the pressure supply, even if one wheel circuit fails, it can be isolated via the circuit isolating valve so that the remaining wheel circuit of the respective brake circuit is still effective. This achieves double fault tolerance with a vehicle deceleration of 0.65 g, for example.

In addition to the valve concepts described, different pressure supply concepts are also possible, e.g., a single pressure supply for Level 2 automated driving or two pressure supplies for Levels 3 to 5 automated driving, whereby the second, redundant pressure supply can include a piston pump or a rotary pump. Rotary pumps have a significant cost advantage. In the case of the piston pump, a simple check valve can be used at the outlet of the pressure supply instead of the solenoid valve, which has the same advantages in the event of a pressure supply failure and is more cost-effective. In this braking system, the pressure reduction during normal braking cannot be achieved by controlling the piston of the pressure supply, but by controlling the outlet valves using the pressure sensor signal.

Solenoid valves can be provided to separate the pressure supply from the brake circuits. However, it is also possible to dispense with such isolation valves if the pressure supply is equipped with a drive with redundant winding circuitry, e.g., 2×3 phases and/or redundant control, such that no further valves are provided between the switching valves assigned to the wheel circuits and the pressure supply. In order to prevent a failure of the braking system, e.g., due to a leaky piston seal or small piston play, compensation is provided by after-feed.

An advantage of the braking systems described above is that the usual vehicle tuning in various areas such as logistics, service, and homologation is no longer necessary.

A braking system according to an example embodiment of the present invention thus includes four wheel circuits that are controlled individually. As described above, two wheel circuits can be assigned to one brake circuit. Other distributions to the brake circuits, as described above, are also possible.

However, the 4-wheel circuit braking system can also be controlled by the control system as a 2-circuit braking system. This means that the 4-wheel circuit braking system can be combined with 2-circuit braking systems with four hydraulically braked wheels, thereby achieving double-fail-safe reliability. This means that even a leak in a wheel brake cylinder and the failure of the control system for the associated switch valve will not lead to a total failure of the braking system. This double fault occurs with a low probability of failure of approximately 10-19/year, which is still significantly better than nuclear power safety. Even with this double fault, the braking system according to an example embodiment of the present invention would still achieve the braking effect of a conventional 2-circuit braking system.

The braking system can therefore be described as fail-safe and fail-secure.

Advantageously, the respective leakage of the individual wheel circuits is diagnosed at intervals or permanently, whereby, depending on the diagnosis result, the electronic control and regulation device of the braking system decides whether a wheel circuit is switched off by permanently closing the associated switching valve 4 continues to be operated to generate a braking effect. If operation is continued, the determined leakage is used to calculate and implement a corresponding additional supply or follow-up supply of brake fluid so that the required braking effect of the respective wheel brake cylinder is achieved.

In order to arrive at a braking system according to an example embodiment of the present invention based on known braking systems, the known inlet valves with check valves simply need to be replaced by the modified switching valve, which incurs virtually no additional costs.

The switch valve has further potential, which is utilized in the event of failure of the outlet valve assigned to the respective wheel circuit. If, for example, the control of the outlet valve fails, ABS pressure reduction via the outlet valve is no longer possible, i.e., the corresponding wheel locks with a loss of braking distance and lateral stability. However, since the switch valve can be used in both directions for pressure build-up and pressure reduction, as it is pull-in resistant, it can also be used for pressure reduction if, for example, the pressure supply can accommodate the volume required for pressure reduction. Since the switch valves do not contain a check valve, when pressure is reduced in one wheel brake cylinder, e.g., RZ1 via SV₁, the pressure in the other wheel brake cylinders is not reduced at the same time, e.g., the wheel brake cylinders RZ2, RZ3, and RZ4 with closed valves SV₂, SV₃, SV₄. As described in earlier patent applications, this can be advantageously achieved with volume control of the piston of the pressure supply or also with a rotary pump. For ABS control, there is only a minor disadvantage due to a small time delay of the pump for volume intake to reduce pressure, as well as for volume provision for pressure build-up. However, this is extremely rare, as it only occurs when the outlet valve fails. However, wheel lockup during ABS operation must be avoided at all costs, especially in braking systems for automated driving at level >3. Since this method does not require any changes or costs other than a software modification, this solution can also be used in braking systems designed for level 2 requirements.

The switch valve thus has a variety of functions in a safety-related braking system according to an example embodiment of the present invention including:
Improved braking effect in the event of a wheel brake cylinder or wheel circuit failure
Maintenance of the pressure reduction control function in ABS in the event of failure Opening of the outlet valve
Savings on additional isolation valves to prevent circuit failure For these fault cases, it is advisable to design the switch valve with redundant coils with connections, as the coil with electrical connection represents the main point of failure.

Diagnosing the switching device is very important to prevent tearing or if a switching valve SV, SVx, or SV₂ₖ does not switch. The following main faults (not exhaustive) are preferably diagnosed:
Pressure supply DV: Failure during pressure reduction control, resulting in increased pressure reduction speed.
Measure 1: Winding circuit in case of failure of the pressure supply motor pressure supply motor or failure of the electronic control and control unit ECU.
Measure 2: Check valve/throttle combination in the hydraulic line from the pressure supply to the brake circuit (see FIG. 4 and FIG. 6).
Switching valve SVi is leaking:
Diagnosis 1: during general diagnostic testing of the valves;
Diagnosis 2: in the event of failure of a wheel brake cylinder and leakage of the associated switch valve SV, follow-up with the pressure as described. Detection via volume increase of the braking system during pressure build-up using the pressure-volume characteristic curve.
Separator valve TV is leaking:
Diagnosis via volume recording of the braking system during pressure build-up using the pressure-volume characteristic curve and follow-up delivery with the pressure supply;
TV isolation valve has too small a cross-section:
Pressure reduction is too slow. Detection via the volume flowing through the master brake cylinder over time during pressure reduction in the brake circuit.

In the system described with an electric motor brake (EMB) on the rear axle, the so-called redundant outlet valve AV_{red}, as an outlet valve AV with redundant coil and/or redundant control, together with the switch valve with redundant coil, is regarded as a double-fail-safe hydraulic front axle control, so that in the event of a failure of an electric motor brake (EMB) on the rear axle, more than 70% of the braking effect is still available, which is not achieved by a comparable full EMB with EMB on the rear axle and on the front axle in this consideration in the event of a failure of the EMB on the front axle and, due to the high complexity and thus high failure rate, is to be rated significantly worse by factors.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows a system concept with four wheel circuits and a switching valve SVi according to an example embodiment of the present invention assigned to each wheel circuit RKi.

FIG. 2 shows a conventional ABS inlet valve with check valve EV and two valve variants of the switching valve SVi or SVx and SV₂ₖ according to an example embodiment of the present invention for the four wheel circuits RKi.

FIG. 3 show a previously known 1-box braking system with switching valves SV₁, . . . , SV₄ according to an example embodiment of the present invention instead of the conventional inlet valves.

FIG. 4 shows a previously known 1-box braking system with switching valves SV₁, . . . , SV₄ according to an example embodiment of the present invention instead of the conventional inlet valves.

FIG. 5 shows a braking system according to an example embodiment of the present invention with a single master brake cylinder SHZ, which can be used in particular for a 1-box solution, with switching valves SV₁, . . . , SV₄ according to an example embodiment of the present invention instead of the conventional inlet valves EV with check valve.

FIG. 6 shows the known ABS/ESP systems that have been in use for years and are standard worldwide, whereby these are specially connected to the four-wheel circuit braking system according to an example embodiment of the present invention, with switching valves SV₁, . . . , SV₄ instead of the usual ABS inlet valves EV and a throttle check valve parallel connection RV/Dr3 in each brake circuit.

FIG. 7 shows an extension of the braking system with ABS and ESP function shown and described in FIG. 1, wherein the measures described above are provided here in the form of the switching device at the switching valves SV₁, . . . , SV₄ of the four wheel circuits and the redundant outlet valve AV_{red}.

FIG. 8 shows the braking system according to FIG. 1 with a double-stroke piston and two 3/2-way valves with an additional pressure relief valve for the 3/2-way valve HZ-BK-WS.

FIG. 9 shows the braking system according to FIG. 1 with an electromechanical brake on the rear axle and 4 circuits and redundant outlet valve AV_{red}.

FIG. 10 shows the braking system according to FIG. 9 with E-pedal and second pressure supply.

### DETAILED DESCRIPTION OF THE EXAMPLE EMBODIMENTS

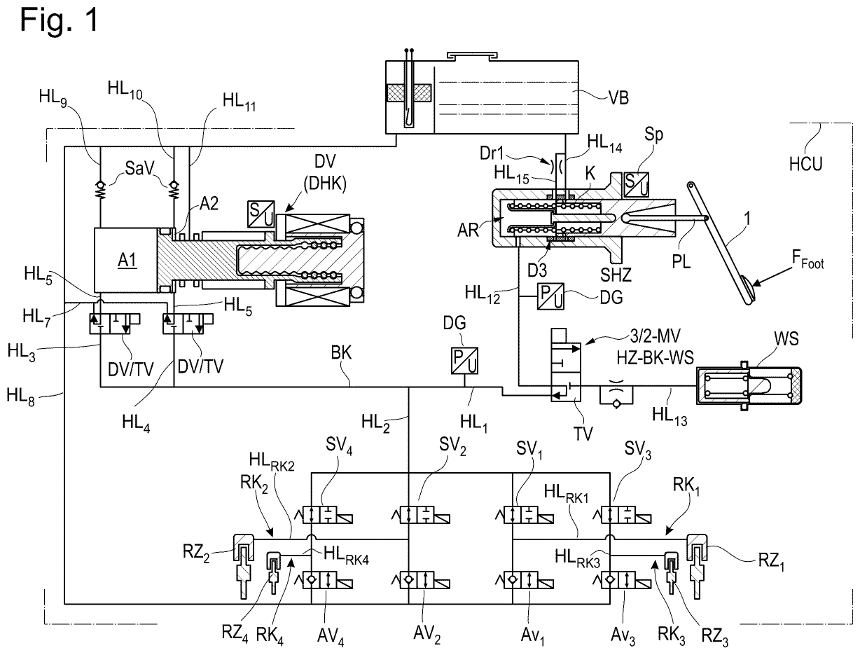

FIG. 1 shows a braking system according to an example embodiment of the present invention. The braking system has four wheel circuits RK₁ to RK₄, wherein the components of a wheel circuit RKᵢ are the respective shift valve SVᵢ, the wheel brake cylinder RZ arranged behind it, and the hydraulic connecting line HL_{RKi} connecting the shift valve SVᵢ to the associated wheel brake cylinder RZᵢ, as well as the optional outlet valve AV.

The braking system has only a single brake circuit BK, to which its hydraulic line HL₁ is connected to all four wheel circuits RK₁₋₄ via at least one hydraulic line HL₂.

The pressure build-up pᵤₚ in a wheel brake cylinder RZᵢ always occurs via the opening of the respective associated switch valve SVᵢ. The pressure reduction p_{down} in a wheel brake cylinder RZᵢ occurs either via the opened corresponding switch valve SVᵢ into the brake circuit BK and/or via the opened corresponding outlet valve AVᵢ and the hydraulic line HL₈ into the reservoir VB.

The braking system also has an electric motor-driven pressure supply DV, which has a piston-cylinder system and is shown in FIG. 1 as a double-stroke piston system (DHK) with two working chambers A1 and A2. It is also possible for the piston-cylinder system of the pressure supply DV to be designed with only one working chamber. The two working chambers A1 and A2 are each connected via hydraulic lines HL5 and HL6 to a shut-off valve DV/TV, which is designed as a 3/2-way valve and connects the associated working chamber A1 or A2 to the reservoir VB when de-energized. When the respective 3/2-way isolation valve DV/TV is energized, the respective working chamber A1 or A2 is connected to the brake circuit BK and pressure can be built up pᵤₚ or reduced pab in at least one wheel brake cylinder RZᵢ by adjusting the piston of the pressure supply DV.

Hydraulic fluid can be sucked from the reservoir VB into the respective working chambers A1 and A2 of the pressure supply DV via the hydraulic lines HL₉ and HL₁₀ and the suction valves SaV arranged therein. Optionally, a further hydraulic line HL₁₁ with a redundant seal can be provided for safety and diagnostic purposes, which opens into an area of the pressure supply cylinder that is separated or sealed from the second working chamber A2 on one side by a seal and on the other side by a further redundant seal, and connects this opening area to the reservoir VB. The failure of the first seal is detected by diagnosis via volume loss during pressure build-up. The failure of the second seal leads to volume loss, which is detected by the liquid level sensor in the reservoir VB.

The braking system also has a master brake cylinder HZ, which is shown in FIG. 1 as a single master brake cylinder SHZ. The single master cylinder SHZ is adjusted by applying a foot force F_{foot} to the brake pedal 1, whereby the adjustment is detected by a travel sensor Sp and the braking system adjusts or regulates the braking effect based on this input variable, among other things.

The single master brake cylinder DHZ has a hydraulically acting working chamber AR, which is connected via a hydraulic line HL₁₂ to a 3/2-way valve HZ-BK-WS. The 3/2-way valve HZ-BK-WS connects the hydraulic line HL₁₂ in the de-energized state with the hydraulic line HL₁ of the brake circuit BK, so that in an emergency, pressure can be built up in the working chamber AR and thus in the braking system via the brake pedal 1 and the associated adjustment of the piston of the single master brake cylinder SHZ, and a braking effect can be achieved. During normal operation of the braking system, however, the switch valve HZ-BK-WS is switched and the working chamber AR of the single master brake cylinder SHZ is connected to the travel simulator WS or the connecting line HL₁₃. This achieves a desired reaction force on the brake pedal 1 in order to generate a desired pedal feel. A parallel connection of a throttle and a check valve is arranged in the hydraulic line HL₁₃, which is necessary for the travel simulator function.

The single master brake cylinder SHZ is connected to the reservoir via the two hydraulic lines HL₁₄ and HL₁₅, with a throttle Dr1 arranged in the hydraulic line HL₁₅. The mouth areas of the hydraulic lines HL₁₄ and HL₁₅ in the single master brake cylinder are sealed from each other and from the rest of the cylinder area by three seals D1, D2, and D3. When piston K is retracted, which corresponds to a movement to the right in the figure, hydraulic line HL14 opens into the area of piston K, with seals D1 and D2 still sealing against the outer surface of piston K. In this piston position, however, seal D3 does not seal against the piston, so that the working chamber AR is connected to the hydraulic line HL₁₅. This arrangement is known from WO 2019/086502.

The braking system also has two pressure sensors DG for measuring the pressure in the hydraulic lines HL₁ and HL₁₂.

The hydraulic components shown in FIG. 1 can be arranged and combined in a single hydraulic unit HCU. The braking system also has an electronic control and regulation unit ECU, which is not shown.

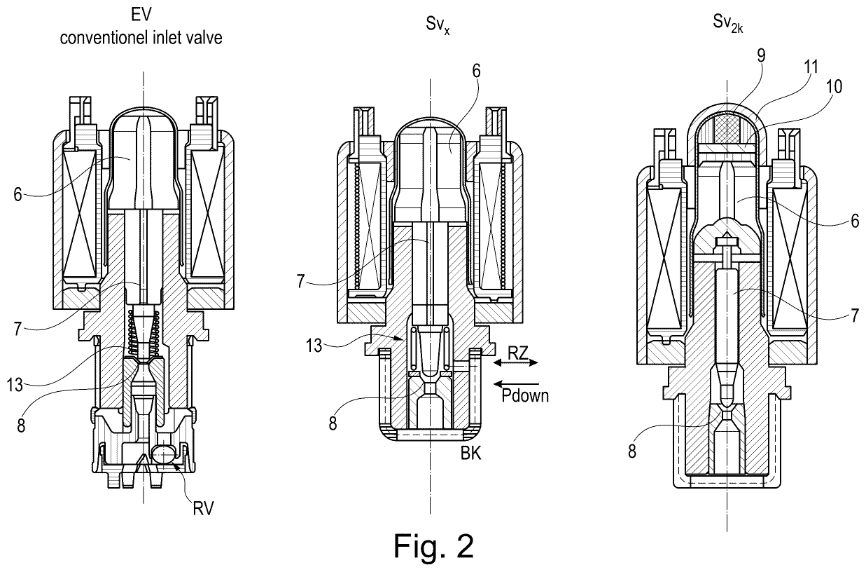

The switching valves SVᵢ are modified conventional ABS inlet valves, the design and function of which are shown and explained in FIG. 2.

FIG. 2 shows three different 2/2-way valves. The standard valve shown on the left corresponds to the inlet valve EV of ABS. A description of this valve can be found in DE 10 2015 203733. It is a so-called SO valve with a check valve RV and a return spring 13 with a special valve seat contour. The other two 2/2-way valves are variants of the SVi switching valve according to an example embodiment of the present invention, which are modified standard ABS inlet valves without a check valve.

The switching valve SV₂ₖ according to an example embodiment of the present invention shown on the right is known from PCT/EP 2022/073463 and has an additional permanent magnet 9, magnetic return 11, and pole plate 10. This replaces the conventional weak return spring 13 with a significantly higher return force with an advantageous decreasing force at the end of the stroke. This is intended to prevent closing at high flow rates and volumes, for example.

The SVx switching valve shown in the middle is designed without a permanent magnet and also without a check valve. It has a significantly higher restoring force of approximately 4N than the standard valve EV shown on the left. In extreme cases, tearing during pressure reduction from the wheel circuits RK to the brake circuit BK is prevented here on the one hand by the stronger restoring spring 13 and on the other hand by the following optional additional measures 1a) to 2a).

In normal circumstances, the SVi switch valve can only tear under two situations when there is extremely high volume flow during pressure reduction:
1. Uncontrolled piston speed of the pressure supply, which can occur in the event of engine control failure and ECU failure;
2. If the flow cross-section of the shut-off valve TV from the brake circuit BK to the master brake cylinder SHZ is too large;

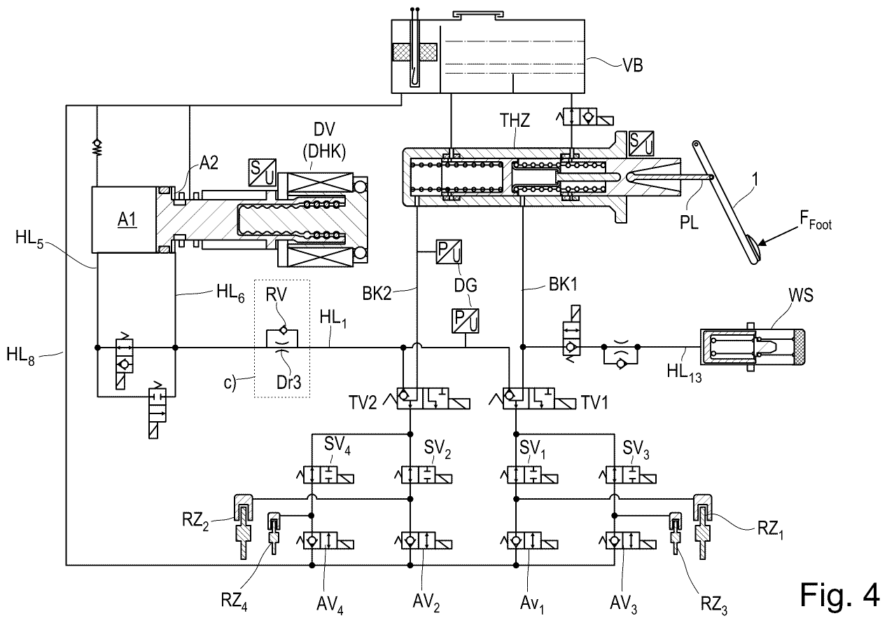

Additional measures for 1. and 2.:
1a: Closing the DV/TV isolating valve separates the BK brake circuit from the DV pressure supply so that the tightness of this valve can be diagnosed.
1b: If the DV/TV valve is not present or in the event of failure of this valve, a parallel connection including throttle Dr3 with a parallel-connected check valve RV in the connecting line can be provided, which only throttles the pressure reduction but not the pressure build-up (see FIG. 4).
1c: Limitation of the motor speed in the event of failure of the motor control or the electronic control unit ECU of the braking system by connecting the winding of the electric drive of the pressure supply only in the event of this malfunction;
2a: Limitation of the valve cross-sections of the 2/2-or 3/3-way shut-off valve TV for pressure reduction, already in series production for cost reasons, as it is only effective in the fallback level in the event of a failure of the pressure supply DV

The diagnosis is just as important as the additional measures.

Diagnosis for 1:
1a: Isolation valve TV is activated (closed). Measurement of DHK stroke with calculation of the displaced volume and pressure in the brake circuit BK. If, during the forward stroke of the double-stroke piston DHK, the volume displaced from the working chamber A1 and the resulting pressure change in the brake circuit BK correspond to the pressure-volume characteristic stored in the control unit, then the 3/2-way valve DV/TV belonging to the working chamber A2 is tight. Conversely, if during the return stroke of the double-acting piston DHK the volume displaced from the working chamber A2 and the resulting pressure change in the brake circuit BK correspond to the pressure-volume characteristic stored in the control unit, then the 3/2-way valve DV/TV belonging to the working chamber Al is tight.

This diagnosis can also be performed with the SV valves closed, but then using a different pressure-volume characteristic curve.
1b: See FIG. 4. The TV isolating valve is activated (closed).

Measurement of pressure and calculation of pressure drop rate in the BK brake circuit. Pressure is generated in the BK brake circuit using the DV pressure supply, e.g. to 100 bar. The pressure in the brake circuit BK is then reduced as quickly as possible using the pressure supply DV. If the pressure drop rate in the brake circuit BK is significantly lower than that stored in the control unit, then the throttle Dr3 is blocked. If the pressure drop rate in the brake circuit BK is significantly higher than that stored in the control unit, then the check valve RV is leaking.

To diagnose the motor winding circuit during pressure reduction: measure the change in volume over time with the pressure supply DV and measure the piston stroke and pressure. 1c: Isolation valve TV is activated (closed). Measure pressure and calculate pressure drop rate in brake circuit BK. Pressure is generated in brake circuit BK using pressure supply DV, e.g., to 100 bar. Then switch off the motor control. If the pressure drop rate in the brake circuit BK is significantly greater than that stored in the control unit, then the wiring of the electric drive winding of the pressure supply is faulty.

Diagnosis of the switching valves SV The shut-off valve TV and switching valves SV₁, . . . , SV₄ are activated (closed). Measure the pressure in the brake circuit BK and the DHK piston displacement. The brake circuit BK is pressurized with the pressure supply DV, e.g., 100 bar. If the pressure in the brake circuit BK can then be maintained without the DHK piston having to be displaced significantly, all switching valves SV are tight. If this is not the case, switching valve SV₁ is opened and the pressure in the brake circuit BK is brought back to 100 bar, for example, using the pressure supply DV. If the pressure in the brake circuit BK can then be maintained without the DHK piston having to be moved significantly, then switching valve SV₁ is leaking. If this is not the case, switching valve SV₂ is opened and the pressure in the brake circuit BK is brought back up to 100 bar, for example, using the pressure supply DV. If the pressure in the brake circuit BK can then be maintained without the DHK piston having to be moved significantly, then the switch valve SV₂ is leaking. If this is not the case, then the switch valve SV₃ is opened and the pressure in the brake circuit BK is brought back up to 100 bar, for example, using the pressure supply DV. If the pressure in the brake circuit BK can then be maintained without the DHK piston having to be moved significantly, then the switch valve SV₃ is leaking. If this is not the case, then the switch valve SV₄ is opened and the pressure in the brake circuit BK is brought back up to 100 bar, for example, using the pressure supply DV. If the pressure in the brake circuit BK can then be maintained without the DHK piston having to be moved significantly, then the switch valve SV₄ is leaking. If this is not the case, then all SV valves are tight and the leak is elsewhere, e.g., in the isolation valve TV.

### Re 2a:

Pressure reduction via the master brake cylinder, e. g., measurement of pressure drop over time with the TV isolation valve open from the BK brake circuit to the SHZ/THZ master brake cylinder and the SVi switch valves open.

A hydraulically optimized valve seat design can also help to reduce or minimize the tear-off force. The return spring force RF is determined by the valve control during pressure build-up via PWM and is used as the global standard for finely metered, precise pressure build-up, which is still possible even with the higher return spring force FR, if necessary with optimization of the control.

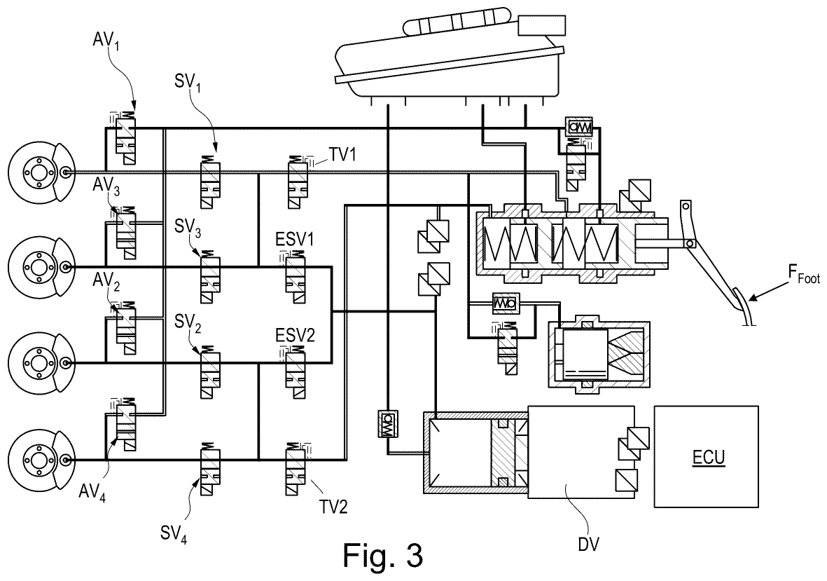

FIGS. 3 to 6 show well-known braking systems from renowned manufacturers, which have been slightly modified in accordance with the invention by replacing the inlet valves with SVi switching valves. Without these modifications, certain single and double faults can occur, resulting in only a small amount of braking effect being available in these braking systems. Conventionally, a double fault of two brake circuits means a total failure of the braking system with a failure probability of AW=10×ppm/Y×10×ppm/Y=100−10−12/Y, which corresponds to approximately 100 failures per trillion vehicles per year.

The main failure points of the known braking systems are as follows:
Connection to the hydraulic unit (HCU)
Brake line
Connection of brake hose to brake line (not shown in the Figures)
Brake hose
Connection of brake hose to brake caliper (not shown in the Figures)
Brake caliper
Wheel brake cylinder seal RZ
Check valve of the inlet valve

Outlet valve AV: The AV is a critical component for brake circuit failure in ABS; for example, dirt particles in the valve seat can cause brake circuit failure with a significant loss of braking effect.

By using the switching valves according to an example embodiment of the present invention, which are modified conventional ABS inlet valves without a check valve, as well as the additional measures b) to f) described above to prevent the switching valve from closing during rapid pressure reduction, these braking systems can be made more fail-safe without great effort and without changing the entire braking system concept.

The braking systems shown in FIGS. 3 to 5 have a significantly lower failure rate due to the elimination of the check valves RV in the switching valves, which means that the probability of failure is significantly lower than in the original braking systems and, in addition, an increased braking effect is advantageously available, since now usually only one wheel circuit fails.

The following section explains in more detail for the individual braking systems in FIGS. 3 to 6 how the additional measures can reliably prevent the SVi switching valves from sticking when the pressure p_{down} drops.

In the braking system shown in FIG. 3, the pressure control for pᵤₚ and p_{down} is carried out in the same way as in the system shown in FIG. 1 by the pressure supply DV. If the pressure supply DV or the electrical control and regulation device ECU fails, the switch valves ESV1 and ESV2 close and the pressure reduction p_{down} occurs via the tandem master brake cylinder THZ, whereby the flow rate over time, which flows out of the wheel brake cylinders into the brake circuit through the switch valves SVi, is limited by the correspondingly small flow cross-section of the isolation valves TV1 and TV2, so that the switch valves SVᵢ₌₁₋₄ is reliably prevented, see additional measure 2a.

The braking system shown in FIG. 4 is very similar in design to the braking system shown in FIG. 3. Unlike the braking system shown in FIG. 3, the braking system shown in FIG. 4 has a check valve/throttle parallel connection RV/Dr3 in the brake line. The parallel connection designated as measure c) leads to a throttling of the volume flow during pressure reduction pab by the throttle Dr3 and guarantees an unlimited pressure build-up pᵤₚ via the check valve RV. In the event of a failure of the pressure supply DV or the electrical control and regulation device ECU, the 3/2-way isolation valves TV1 and TV2 switch to the valve positions shown, so that the pressure reduction p_{down} takes place via the tandem master brake cylinder THZ, whereby the flow rate which flows through the switching valves SVᵢ₌₁₋₄ from the wheel brake cylinders into the brake circuits BK1 and BK2 is limited by the correspondingly small flow cross-section of the 3/2-way isolation valves TV1 and TV2, so that closing of the switching valves SVᵢ₌₁₋₄ is reliably prevented in this case as well.

Additional measure 1b can be used here as redundancy for possible faults in valve TV1 and valve TV.

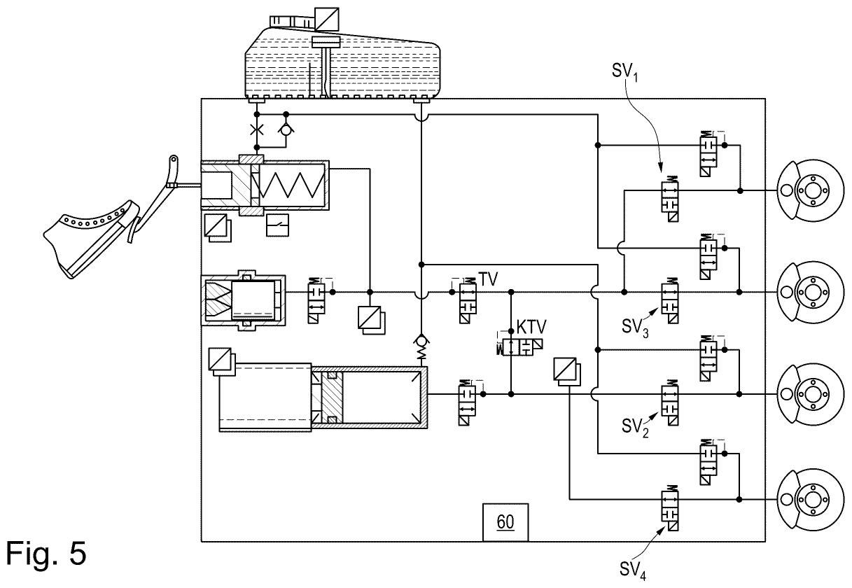

In the braking system shown in FIG. 5, the volume flow is limited over time during pressure reduction in normal operation via the pressure supply DV, in particular via the piston speed, whereas in the event of a failure of the pressure supply or the ECU, the pressure reduction is carried out via the 2/2-way isolation valve TV and the main brake cylinder SHZ with a corresponding cross-section to the single main brake cylinder SHZ, with a corresponding time limitation of the volume flow to the main brake cylinder SHZ/THZ.

In the system shown in FIG. 5 without the switching valves SV according to an example embodiment of the present invention, i.e., with the previous ABS inlet valves EV with check valve RV, the circuit isolating valve KTV remains open in the event of a failure of the electronic control and regulation unit ECU. A further additional failure of a wheel brake cylinder RZ then causes a total failure of the brake. With the switching valves SVi according to an example embodiment of the present invention, only one wheel circuit fails in the event of a wheel brake cylinder RZ failure, leaving a residual braking effect of at least 65%, for example. In the event of two wheel brake cylinder RZ failures and ECU failure, two wheel brake cylinders remain effective if the circuit isolating valve KTV is switched differently (closed when de-energized).

The throttling of the volume flow during pressure reduction can be limited to the corresponding control of the pressure supply DV. In the event of a failure of the pressure supply DV or the electronic control and regulation device ECU, the corresponding solenoid valves close and the pressure reduction p_{down} takes place via the 2/2-way shut-off valve TV, which limits the flow rate by the dimensioning of its flow cross-section.

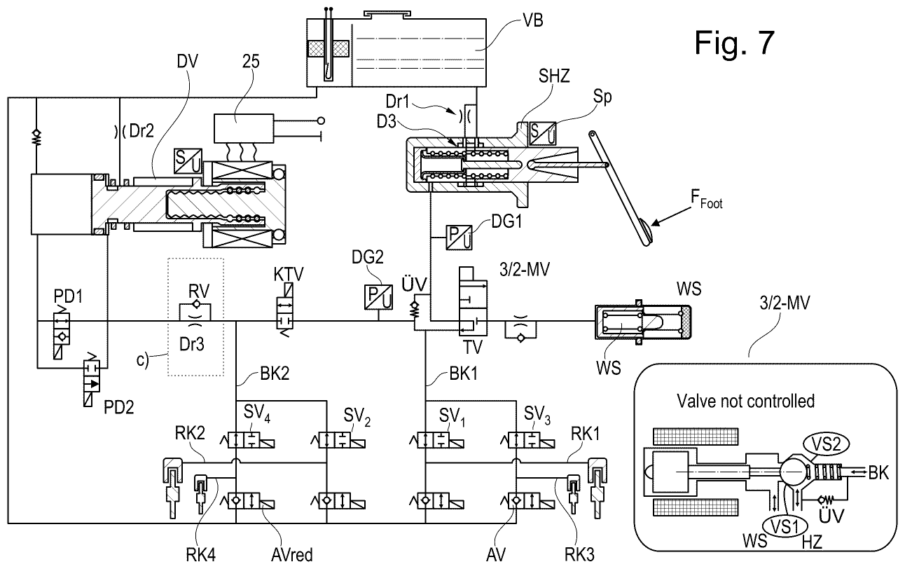

In all the braking systems shown and described in FIGS. 3 to 5, a redundant outlet valve AV, AV_{red} can also be used, as is known from PCT/EP 2022/059069. Furthermore, in the event of failure of an outlet valve AV, e.g., to reduce pressure in ABS due to its defective electrical control, the pressure supply DV can, in this case, take over not only the pressure build-up but also the pressure reduction via the switching valves SVᵢ, as explained in more detail in FIG. 7 below. This measure is particularly advantageous because, apart from minor changes to the software, no additional technical measures or costs are necessary.

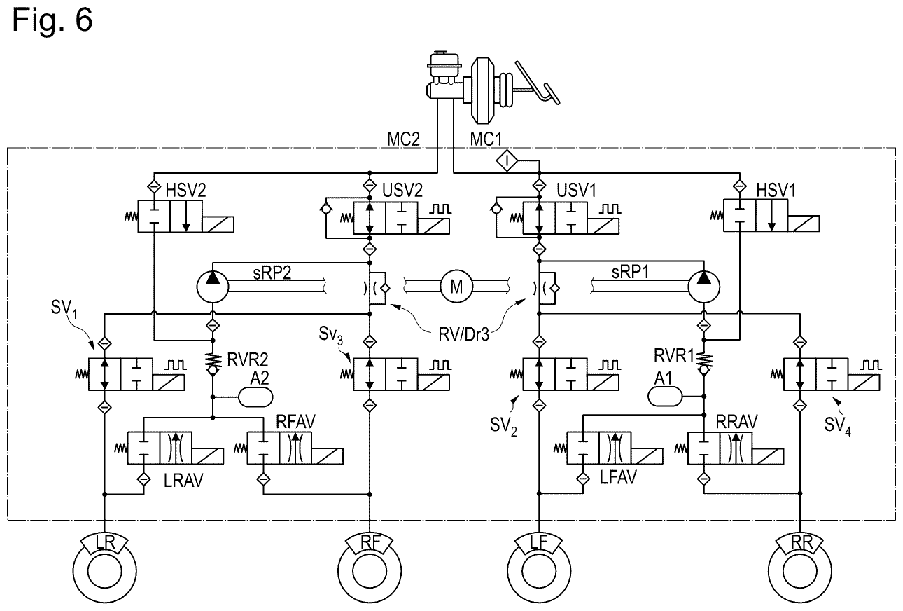

In the braking system shown in FIG. 6, the two parallel circuits including throttle Dr3 and check valve RV (see additional measure 2b) are provided to throttle the volume flow and prevent the switching valves SVᵢ from closing when the pressure is reduced. The parallel connection including check valve RV and throttle Dr3 can also be arranged outside the ESP system in a brake line leading to the master brake cylinder.

The braking system works in principle like the braking systems described in FIGS. 3 to 5. In the system shown in FIG. 6, a hydraulic brake booster, electric brake booster, hydraulic E-boost, or vacuum booster can be provided as the master brake cylinder. Its failure can lead to excessive pressure reduction speed when slipping off the pedal, which can cause the problem of closing a shift valve SVi. For this reason, a combination of a check valve RV and a throttle Dr3 is used in the main line to the BK or booster, which only throttles the pressure reduction p_{ab}. As explained previously for the other braking systems, the check valve RV enables rapid pressure build-up.

The braking system shown in FIG. 7 corresponds to a new system design and is based on the braking system shown in FIG. 1. The wheel circuits RKi, the pressure supply DV, and the single master brake cylinder SHZ are taken from the braking system shown in FIG. 1. The difference to the braking system shown in FIG. 1 is that a circuit isolating valve KTV is provided, which separates the brake circuits BK1 and BK2. In addition, the 3/2-way valves DV/TV are replaced by the valves PD1 and PD2, and a pressure relief valve ÜV is provided, which connects the master brake cylinder SHZ/THZ to the brake circuit BK when a certain pressure difference is reached.

The pressure sensor DG1 is used to monitor the pressure in the master brake cylinder SHZ/THZ together with the path simulator WS, which are hydraulically connected to each other during normal operation by the 3/2-way valve 3/2-MV.

The pressure sensor DG2 is used to control the pressure supply DV. The circuit isolating valve KTV is a normally closed valve, in contrast to the circuit isolating valve KTV in the braking system shown in FIG. 5, which is a normally open valve.

As shown in FIG. 5, the circuit isolating valve KTV can therefore be selected to be normally closed, in contrast to the prior art, in which the circuit isolating valve KTV is normally open, and in the event of an ECU failure, in which the brake booster fails, and an additional failure of the brake circuit BK2, the master brake cylinder SHZ/THZ acts without amplification only on one brake circuit BK1 and, in the worst case, only a deceleration of approximately 0.3 g is achieved.

Furthermore, the system includes the usual ABS valve circuit with SVᵢ₌₁₋₄ and AV. This means that the system is redundant even if a wheel brake cylinder RZ fails and is also extremely safe even if an outlet valve AV fails. If, for example, the control of an outlet valve AV is defective and control is no longer possible, in principle no further pressure reduction is possible. In this case, the pressure supply DV reduces the pressure in the wheel circuit RK with the failed outlet valve AV via the piston movement and takes over the pressure reduction p_{down}, with the remaining switch valves SVi closed. The subsequent pressure build-up takes place as usual, i.e., in the extreme case of an outlet valve AV failure with 1 ppm/year, this measure would be necessary. The minor restriction that during this period of pressure reduction in a wheel brake cylinder, an individual pressure build-up pup is not possible is completely negligible.

The cost of the software change is minimal. A failure probability AW of 4×1 ppm=4 ppm/year is likely, whereby the failure of a locking wheel, for example on a wet road, could result in an accident. For braking systems from level 3 onwards, this is probably a requirement that must be met. Alternatively, a redundant outlet valve AV_{red} can be used.

The pressure supply DV is a pressure supply described in DE 102017000472 with a so-called double-stroke piston and two 2/2-way valves PD1 and PD2 for the forward and return strokes. In the initial position of the piston, there is a connection from the brake circuit BK2 to the reservoir VB. For the 4-circuit system, failure of the motor or the ECU electrical control and regulation device must be taken into account. In this case, high pressure in the brake circuit can cause the piston to return unchecked, leading to the SVi switch valve tearing. To prevent this, a parallel connection of throttle Dr3 and check valve RV is provided, which prevents excessive flow velocities when the pressure p_{down} drops.

In this context, a second throttle Dr2 is provided, which allows a small leakage flow, i.e., pedal travel loss, in the event of the above-mentioned failure. Alternatively, the KTV, which is closed when de-energized, can also perform this function. In the event of a failure of the electric drive of the pressure supply DV with rapid motor return, an additional electrical circuit can also be used, which, in the event of an ECU failure, short-circuits at least one winding of the drive so that the drive acts as a brake for the piston movement of the pressure supply DV.

The bottom right of FIG. 7 shows the schematic diagram of the 3/2-way solenoid valve, whereby two special features must be taken into account. The pressure in the brake circuit BK1 opens the valve SV₂, i.e. if the pressure supply DV or the ECU fails, the pressure in the brake circuit is not trapped via the 3/2-MV. On the other hand, the parallel-connected pressure relief valve ÜV is used, which, in the event of extremely high pressure in the (single) master brake cylinder SHZ/THZ and also failure of the pressure supply DV or ECU, still allows pressure p(ᵤₚ₎ to build up from the (single) master brake cylinder SHZ/THZ into the brake circuit BK1. The parallel-connected pressure relief valve UV thus allows a p (ᵤₚ₎ into the brake circuit BK1 via the SHZ even in the event of extremely high pressure in the (single) master brake cylinder SHZ/THZ and simultaneous failure of the pressure supply DV or the ECU.

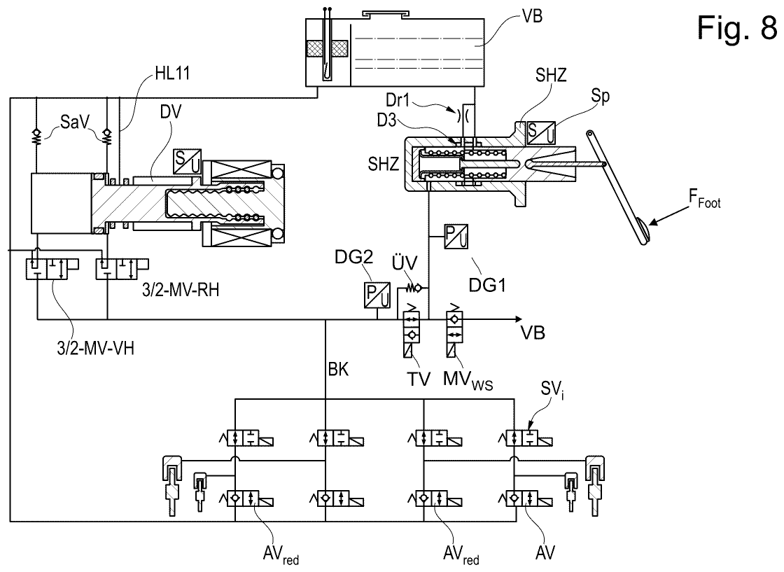

FIG. 8 shows a braking system similar to FIG. 1, with the difference that the pressure relief valve ÜV described in FIG. 7 is also used. This braking system meets extreme requirements for double-fail-safe operation, e.g., failure of a wheel circuit RK and failure of its switching valve SVi with a failure probability AW of 10 ppm*1ppm=10×10(^{-12)/J}, which is 10 times smaller than a double brake circuit failure with 100*10(^{-12)/Y}. Further measures can be taken to increase reliability, e.g., the switching valve SV (i₎ can also be controlled redundantly, e.g., with a redundant coil, which brings the failure probability AW in the example into the range of 10 (^{-17)/Y}.

This concept is more cost-effective than providing a circuit isolating valve KTV, which compensates for the disadvantage of a pressure difference in both brake circuits BK1 and BK2 during rapid pressure build-up pᵤₚ.

In this system, the usual path simulator with piston is removed. Instead, a pedal force control is used, in which the pressure in the master brake cylinder SHZ/THZ is controlled according to the desired pedal characteristics stored in the ECU control unit with the aid of the pressure supply DV, the pressure sensor DG1, the pedal travel sensor Sp, and two valves, the isolating valve TV and the path simulator valve MV_{WS}. Together with the pressure sensor DG1 and the pedal travel sensor Sp, the isolating valve TV, together with a relief valve ÜV, is used to increase the pressure in the master brake cylinder SHZ/THZ (pedal force increase) with the aid of the pressure supply DV, and the second solenoid valve MV_{WS} is used to reduce pressure in the master brake cylinder SHZ/THZ (pedal force reduction).

To limit pressure reduction p_{down}, the pressure supply in normal operation and the shut-off valve TV with reduced cross-section are used in the event of a failure of the pressure supply or ECU.

To prevent the SVi switching valves from tearing in the event of a double fault, DHK failure, and failure of a 3/2-way valve 3/2-MV-RH, additional measure 1b is available, and in the event of pressure reduction via the main brake cylinder SHZ/THZ, additional measure 2a is available.

The double-stroke piston DHK of the pressure supply DV has two suction valves SaV and, optionally, an additional return line HL11 to the reservoir VB. A 3/2 MV is provided here for both the forward stroke VH and the return stroke RH of the double-acting piston DHK. This allows all functions necessary for control, such as pressure build-up pᵤₚ and pressure reduction p_{down}, to be implemented for both the forward stroke VH and the return stroke RH. In addition, if a 3/2 MV-RH or 3/2 MV-VH fails, the other 3/2 MV is always available for forward or return stroke, with the minor disadvantage that if a 3/2 MV valve fails and the switchover from 100 to 200 bar occurs, the switchover time also acts as a loss of time. Statistically, a pressure greater than 100 bar is only required in approximately 10% of braking operations. This valve circuit also has the advantage of so-called piston area switching, i.e., in the higher pressure range, only the small area of approximately 50% is effective, with the advantage of correspondingly lower spindle force and motor torque dimensioning.

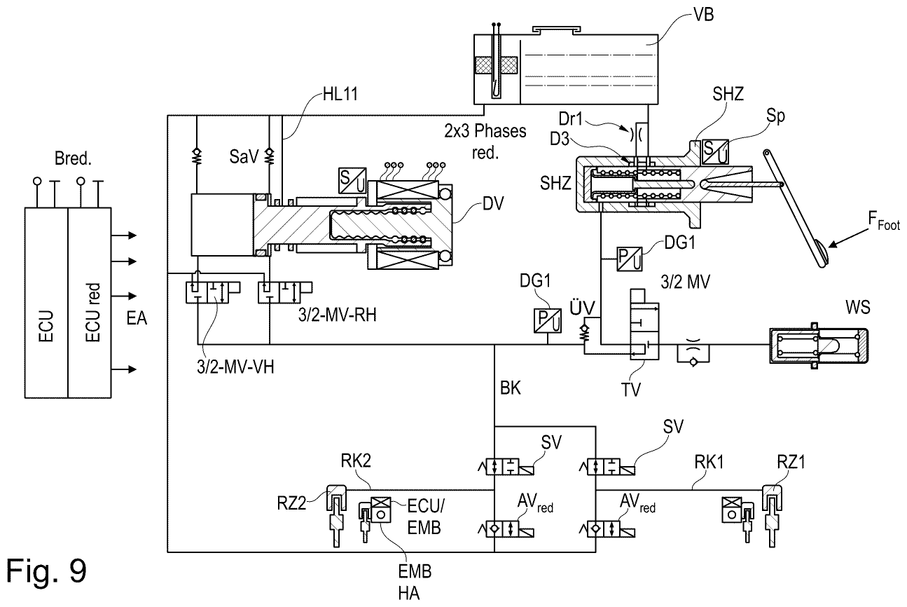

The braking system shown in FIG. 9 corresponds to the braking system shown in FIGS. 7 and 8 in terms of its main components: reservoir VB, single master cylinder SHZ, 3/2-way shut-off valve TV to the path simulator WS, and pressure supply DV.

The difference lies in the rear axle brake, which is designed with the familiar EMB electric motor brake with integrated ECU. Therefore, we will not describe the EMB here. The difference lies in the hydraulic control of the front axle brake. This is achieved either via a 2×3 phase control of the EC motor of the pressure supply DV and the 4-circuit system proposal with the SVi switching valves according to an example embodiment of the present invention and, if necessary, redundant outlet valve AV_{red}.

This means that if wheel circuit RK 1 or RK2 fails, the other wheel circuit is still functional and a total braking effect of over 60% and additional safety is achieved due to the SVi switching valves according to an example embodiment of the present invention, a possible redundant control of the SVi switching valves and a possible redundant coil of the SVi switching valve. In addition, a failure of an ABS outlet valve with control of the pressure supply DV and the switching valve SV, as described in FIG. 7, can be avoided.

This braking system according to an example embodiment of the present invention thus offers a very high level of safety and is also characterized by its simple design, which saves not only manufacturing costs but also service costs.

If there is limited installation space on the front wall, the master brake cylinder SHZ/THZ can be separated from the other hydraulic components and integrated into the pedal block.

The electrical control and regulation unit ECU is also not described in detail for the reasons mentioned above. Shown here is the electrical control and regulation unit ECU with on-board power supply connection, which can optionally be designed redundantly (B_{red}), with the corresponding ECU configuration, with the EA connection to all electrical and electronic consumers.

If necessary, a redundant pressure supply DV can be used for levels L3 and L4 of automated driving for the front axle, even though the rear axle EMB is fully functional. A redundant ECU can also be used for the above requirements. Here too, the additional measures for preventing tearing described and illustrated in FIG. 8 apply.

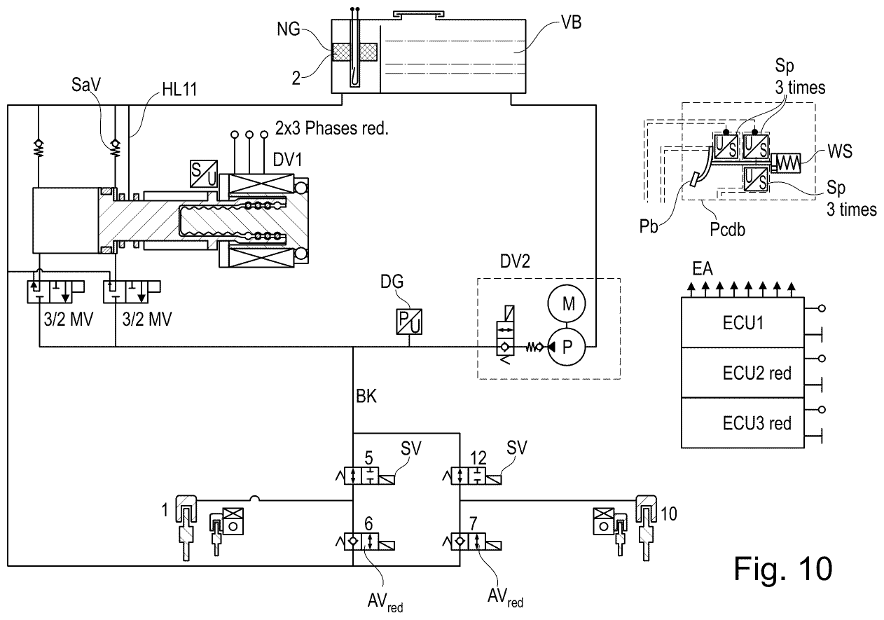

FIG. 10 shows a similar system design with the difference that instead of the main brake cylinder SHZ/THZ, a so-called E-pedal or, in the case of level L5 automated driving, a fully electronic brake control system without a pedal can be used. Since the mechanical-hydraulic fallback level is omitted here, high safety requirements are imposed, preferably with triple redundancy, as described in aircraft construction and for the E-pedal in DE102019483.

In addition to the first pressure Supply DV, DV1 with optional 2×3 phase redundancy, a second pressure supply DV2 can be provided, which may also have additional 2×3 phase control. The level indicator NG in the storage tank VB can also advantageously be designed to be redundant and preferably arranged with a sensor element in the control and regulation unit ECU.

Measures 1a to 2a can also be provided in this system according to an example embodiment of the present invention. Here, too, the switching device is included, and, for example, the winding short circuit of FIG. 7 can be used in the event of motor failure.

The diagnosis to prevent tearing of a switching valve SVᵢ₌₁₋₄ is performed using the following measures.

In the event of a failure of the pressure supply, the pressure curve and/or the piston speed of the pressure supply are monitored during pressure reduction, whereby, if a certain piston speed or an excessive pressure change speed is exceeded, the motor winding of the drive motor of the pressure supply is connected, in particular short-circuited, by an electrical switching device, so that the drive acts as a brake.

### Measures Against Tearing SV:

1. In the event of failure or leakage of a switch valve or wheel brake cylinder: these faults can only be reliably detected when the switch valve fails, with appropriate diagnosis, e. g., when the vehicle is stationary via the pressure curve in the brake circuit when all switch valves SVᵢ₌₁₋₄ are closed. If a wheel brake cylinder fails, the volume is compensated for by the pressure supply and the wheel brake cylinder or wheel circuit can continue to operate to a certain degree of leakage, which means that the braking effect of this wheel brake cylinder is not completely lost.
a. The TV isolation valve to the SHZ/THZ master brake cylinder is leaking: Detection via pressure curve in the brake circuit BK and master brake cylinder SHZ/THZ, also additional compensation via the control of the pressure supply DV and the shut-off valve TV. The engine speed is dampened again via the engine winding.
b. Combination of check valve RV and throttle Dr3 in hydraulic line to pressure supply DV.
2. Tearing of the switching valve SVᵢ₌₁₋₄ due to excessive piston speed of the DV pressure supply during pressure reduction.

Detection via pressure curve in the brake circuit: Pressure reduction is faster because the SV is stuck in a wheel cylinder.

Separator valve with altered cross-section during pressure reduction in the main brake cylinder SHZ/THZ. Detection via pressure curve.

Example embodiments of the present invention may include any of the following items. [Item 1] Braking system with at least two wheel brake cylinders (RZ₁₋₄), each of which is part, separate wheel circuits (RK₁₋₄), at least one electrically driven pressure supply (DV), which serves at least to build up pressure (pᵤₚ) and reduce pressure (p_{down}) in the wheel brake cylinders (RZ₁₋₄), at least one reservoir (VB), at least one electronic control and regulation device (ECU) at least two switching valves (SVᵢ₌₁₋₄), wherein each wheel brake cylinder (RZ₁₋₄) is connected via a respective hydraulic connecting line to a switching valve (SVᵢ₌₁₋₄) , which is used to disconnect and connect the hydraulic connection of the respective wheel brake cylinder (RZ₁₋₄) and at least one other hydraulic main line, via the switching valve (SVᵢ₌₁₋₄) is connected or connectable at least to the pressure supply (DV), and that the switching valves (SVᵢ₌₁₋₄) are normally open 2/2-way valves, wherein at least the hydraulic connecting line (HL_{RK1-4}) and the wheel brake cylinder (RZ₁₋₄) connected thereto are components of a wheel circuit (RK₁₋₄), and that at least one switch valve (SVᵢ₌₁₋₄) or all switching valves (SVᵢ₌₁₋₄) have no check valve or no check valve is connected in parallel to a switching valve (SVᵢ₌₁₋₄), characterized in that, the following measures are provided, either alone or in combination, to prevent a switching valve (SVᵢ₌₁₋₄) from closing when the pressure is reduced (p_{down}) via this switching valve (SVᵢ₌₁₋₄): a. the valve actuator (7) of the switching valve (SVᵢ₌₁₋₄) is force-loaded with a return force (FR) in its open position, which is at least 30-50% greater than in standard inlet valves in ABS systems, whereby the increased restoring force (FR) is achieved by a stronger return spring (13) and/or by a magnetic force, which acts in addition to the force of the return spring (RF); b) the pressure supply (DV) is used to adjust or regulate the pressure reduction rate (p_{down}/dt) is adjusted or regulated in such a way that closing of the switching valve (SV_{i=1- 4}); c) that in the hydraulic connecting line (HLx) connecting the pressure supply (DV) to the switching valves (SV₁₋₄) a parallel circuit including a throttle (Dr3) and a check valve (RV), wherein the check valve (RV) blocks in the direction of the pressure supply (DV) supply (DV); d) that the shut-off valve (TV), by which the wheel circuits (RK₁₋₄) can be disconnected or connected from a master brake cylinder (HZ; SHZ; THZ), has a flow cross-section which is dimensioned such that, in the event of a pressure drop (p_{down}) in a wheel circuit (RK₁₋₄) via the separator valve (TV) prevents the switching valve (SVᵢ₌₁₋₄) from sticking; e) that the shut-off valve (TV), by which the wheel circuits (RK₁₋₄) can be disconnected or connected from the main brake cylinder (HZ; SHZ; THZ), and via which the pressure reduction in a wheel circuit (RK₁₋₄) takes place, is opened and closed in pulse width mode in order to limit the flow rate or flow velocity to a level such that tearing of the switching valve (SV₁₋₄) is prevented; f) the drive of the pressure supply (DV) is a multiphase motor, whose electrical connection of the windings is designed in such a way that in the event of a failure of the motor control and/or the electrical control device (ECU) of the braking system, the electric motor is operated in operate in generator mode and, due to the winding circuit, of the electric motor acts as a brake for the piston of the pressure supply (DV) and thus the pressure reduction rate (dp_{down}/dt) in the wheel circuits (RKᵢ₌₁₋₄) is limited or slowed down.

[Item 2] Braking system according to Item 1, characterized in that an unthrottled pressure build-up (pᵤₚ) is achieved via the check valve (RV) by the pressure supply (DV).

[Item 3] Braking system according to one of Items 1 to 2, characterized in that hydraulically acting wheel brake cylinders (RZ) are provided for the front axle (VA), and that electromechanical wheel brakes (EMB) are provided for the rear axle (HA), wherein the wheel brake cylinders (RZ) for the front axle are each part of their own wheel circuit (RK₁₋₂).

[Item 4] Braking system according to one of Items 1 to 3, characterized in that the master brake cylinder (HZ) is a single master brake cylinder (SHZ) with only one hydraulic working chamber (A1) or a tandem master brake cylinder (THZ) with two working chambers (A1, A2), wherein the master brake cylinder (HZ) is coupled to a brake pedal (1).

[Item 5] Braking system according to one of Items 1 to 4, characterized in that the brake pedal has an E-pedal.

[Item 6] Braking system according to one of Items 1 to 5, characterized in that the braking system has a travel simulator (WS) which can be hydraulically connected to the master brake cylinder (HZ; SHZ; THZ) via a switching valve, in particular in the form of a 3/2-way valve (TV).

[Item 7] Braking system according to Item 6, characterized in that the 3/2-way valve (3/2-MV) connects the master brake cylinder (SHZ; THZ) to a brake circuit (BK1) when de-energized.

[Item 8] Braking system according to one of Items 1 to 7, characterized in that a pressure relief valve (ÜV) connects the hydraulic line coming from the master brake cylinder (SHZ; THZ) to a brake circuit (BK1), wherein the pressure relief valve (ÜV) blocks in the direction of flow toward the master brake cylinder (SHZ; THZ).

[Item 9] Braking system according to one of Items 1 to 8, characterized in that a circuit isolating valve (KTV), which is closed when de-energized, serves to selectively isolate or connect two brake circuits (BK1, BK2).

[Item 10] Braking system according to one of Items 1 to 9, characterized in that only the front axle (VA) has hydraulic brakes whose braking effect is regulated or controlled by the pressure supply (DV) and that electromechanical brakes (EMB) are provided on the rear axle of the vehicle to achieve a braking effect.

[Item 11] Braking system according to one of Items 1 to 10, characterized in that a particularly redundant outlet valve (AV_{red}) is used to limit the volume flow through this switching valve (SVᵢ) by opening the outlet valve (AV_{red}) in the event of a pressure drop via a switching valve (SVᵢ) (AV_{red}).

[Item 12] Braking system according to one of Items 1 to 11, characterized in that the pressure supply (DV) has a double-acting piston (DHK), whose two working chambers (A1, A2) can be connected either to the brake circuit (BK) or to the reservoir (VB) by two 3/2-way valves (3/2-MV-VH, 3/2-MV-RH) can be selectively connected to the brake circuit (BK) or the reservoir (VB).

[Item 13] Braking system according to one of Items 1 to 12, characterized in that at least one switching valve (SVᵢ) has a redundant drive coil and/or a redundant control.

[Item 14] Braking system according to one of Items 1 to 13, characterized in that, in the event of failure of a 3/2-way valve (3/2-MV-VH, 3/2-MV-RH), the braking system builds up pressure either only in the forward stroke or only in the return stroke of the pressure supply (DV).

[Item 15] Braking system according to one of Items 1 to 14, characterized in that the two 3/2-way valves (3/2-MV-VH, 3/2-MV-RH) it is possible to switch between two modes for pressure build-up (pᵤₚ), whereby in the first mode a lower pressure can be generated by the pressure supply (DV) than in the second mode, in which delivery is effected via the difference areas of the double-stroke piston.

[Item 16] Braking system according to one of Items 1 to 15, characterized in that the master brake cylinder (SHZ, THZ) is arranged separately from the hydraulic unit (HCU), in particular together with the pedal block or integrated into it.

[Item 17] Braking system according to one of Items 1 to 16, characterized in that the reservoir (VB) has a redundant level sensor.

[Item 18] Braking system according to one of Items 1 to 17, characterized in that, in a functional state in which at least one wheel circuit (RK₁₋₄) has a functional fault that exceeds a certain fault severity threshold, the pressure control either permanently closes the switching valve (SVᵢ₌₁₋₄) assigned to this wheel circuit (RK₁₋₄) at least temporarily, or permanently from the rest of the braking system or the other wheel circuits (RK₁₋₄) and/or the pressure supply (DV) and/or by an optional circuit isolating valve (KTV), which is in particular a normally closed valve, or by at least one isolating valve (TV, TV1, TV2), separates at least two wheel circuits (RK₁₋₄) or brake circuits (I, II) from each other or connects them to each other.

[Item 19] Braking system according to Item 18, characterized in that two brake circuits (BK1, BK2), at least one of which is assigned at least two wheel circuits (RKi), can be separated from each other or connected to each other by the circuit isolating valve (KTV, TV1, TV2).

[Item 20] Braking system according to one of Items 1 to 19, characterized in that a diagnosis of the respective leakage of the individual wheel circuits (RK₁₋₄) and that, depending on the diagnosis result, the electronic control and regulation device (ECU) decides whether a wheel circuit (RK₁₋₄) is switched off by permanently closing the associated switching valve (SVᵢ₌₁₋₄) or continues to be operated to generate a braking effect.

[Item 21] System according to one of Items 1 to 20, characterized in that the switching valve (SVᵢ₌₁₋₄) has a return spring (13) which exerts a force on the valve actuator or valve tappet (7), which prevents the valve from closing, at least at low pressures.

[Item 22] Braking system according to one of Items 1 to 21, characterized in that the braking system remains in a first basic operating state or is operated in this state as long as no functional error occurs in any wheel circuit (RK₁₋₄) which has a functional error that exceeds a certain error threshold.

[Item 23] Braking system according to one of Items 1 to 22, characterized in that the braking system has two pressure supplies (DV1, DV2).

[Item 24] Braking system according to Item 23, characterized in that, in a first functional state, either one pressure supply (DV1, DV2) is always assigned to one brake circuit (BK1, BK2) for pressure control in its wheel circuits (RK₁₋₄), or that both pressure supplies (DV1, DV2) are responsible for pressure control for both brake circuits (BK1, BK2) or, in the case of only a single brake circuit (BK), for this circuit together.

[Item 25] Braking system according to Item 23 or 24, characterized in that in the event of a failure of one pressure supply (DV, DV1, DV2), the other pressure supply takes over its function, in particular for all wheel circuits or only some of them.

[Item 26] Braking system according to Items 1 to 25, characterized in that either a) two wheel circuits are each assigned to one brake circuit (BK1, BK2), b) three wheel circuits to a first brake circuit (BK1) and one wheel circuit to a second brake circuit (BK2) (asymmetrical brake circuits), or c) all wheel circuits are assigned to only one single brake circuit.

[Item 27] Braking system according to one of Items 1 to 26, characterized in that each wheel brake cylinder (RZ₁₋₄) is connected via a respective hydraulic connecting line (HL_{RKi}) to a switching valve (SVᵢ₌₁₋₄), which is used to disconnect and connect the hydraulic connection (HL_{RKi}) of the respective wheel brake cylinder (RZ₁₋₄) and at least one further hydraulic main line (HL₂), via which the switch valve (SVᵢ₌₁₋₄) can be connected or is connected at least to the pressure supply (DV), wherein the hydraulic connecting line (HL_{RKi}) and the wheel brake cylinder (RZ₁₋₄) connected thereto are components of a wheel circuit (RK₁₋₄), and that a diagnosis of the respective leakage of the individual wheel circuits (RK₁₋₄) is performed and that, depending on the result of the diagnosis, the electronic control and regulation unit (ECU) decides whether a wheel circuit (RK₁₋₄) is switched off by permanently closing the associated switch valve (SVᵢ₌₁₋₄) or continues to be operated to generate a braking effect.

[Item 28] Braking system according to one of Items 1 to 27, characterized in that the degree of leakage or the leakage flow (Qₗₑₐₖ) in a wheel circuit (RK₁₋₄) is determined using one or more of the following diagnostic methods a) to e): a) Determination of the required amount of hydraulic fluid needed to achieve a target pressure (p_{target}) in the respective wheel circuit (RK₁₋₄) in addition to the predetermined amount of fluid by the pressure supply (DV); b) Determination of a calculated absolute pressure drop (dp_{down}) and/or pressure drop gradient (p_{down})/dt) in the respective wheel circuit (RK1-4); C) Determination of the pressure deviation (dp=P_{target}−P_{actual}) from the target pressure value (pₛₑₜ) during pressure build-up in the respective wheel circuit (RK₁₋₄) by pumping a predetermined amount of fluid (q) into the wheel circuit (RK₁₋₄) to achieve the target pressure (p_{target}) and then determining the actual pressure (p_{actual}); d) Diagnosis of the leakage in the wheel circuit (RK₁₋₄) via measurement of the pressure (p_{actual}) over time measuring the pressure (p_{actual}) in the hydraulic line connecting the switching valve (SV₁₋₄) and the pressure supply (DV) during the pressure build-up by the pressure supply (DV) or when the pressure supply (DV) is switched off; e) Measurement of the intake volume (Q) of the respective wheel circuit (RK₁₋₄) via the pressure supply (DV) to achieve a target pressure (p_{target}), wherein the absorption volume (Q) is determined by the pressure supply (DV), in particular via current measurement of the drive motor (M) of the pressure supply (DV) and/or the piston stroke (ds) of the piston of the pressure supply (DV).

[Item 29] Braking system according to Items 27 or 28, characterized in that when an upper limit value (Q_{high}) or limit value range (dQ_{high}) of the leakage of a wheel circuit (RK₁₋₄) is exceeded, the respective associated switch valve (SV₁₋₄) is permanently closed, thereby preventing any braking action from occurring with this wheel brake cylinder (RZ₁₋₄), and that below the upper limit value (Q_{high}) and above a lower limit value (Q_{low}), a temporary and/or permanent additional supply is provided in order to achieve the brake pressure (p_{target}) to be set in the respective wheel brake cylinder (RZ₁₋₄).

[Item 30] Braking system according to Item 29, characterized in that the upper limit value (Q_{high}) is determined by the maximum delivery capacity of the pressure supply (DV) for increasing the pressure.

[Item 31] Braking system according to Item 29 or 30, characterized in that, in the event of a leakage flow (Qₗₑₐₖ) of 50-90% of the maximum delivery capacity of the pressure supply (DV), the leakage flow (Qₗₑₐₖ) is compensated by the pressure supply (DV) by additional delivery, such that there is no or only a slight reduction in the braking effect.

[Item 32] Braking system according to one of Items 29 to 31, characterized in that, in order to optimize the braking effect and driving stability, in particular the yaw moment and its control by an additional stabilization control system (ESC), an electronic control and regulation device (ECU) determines whether and which leaky wheel circuit(s) (RK₁₋₄) is or are shut off by permanently closing the respective switching valve(s) (SV₁₋₄).

[Item 33] Braking system according to one of Items 1 to 32, characterized in that an outlet valve (AV₁₋₄) belonging to a wheel brake cylinder is part of the respective wheel circuit (RK₁₋₄).

[Item 34] Braking system according to one of Items 1 to 33, characterized in that the braking system has a level sensor for determining the fill level of the reservoir (VB), which is arranged in particular on the printed circuit board (PCB) of the control and regulation device (ECU).

[Item 35] Braking system according to one of 1 to 34, characterized in that at least one pressure supply (DV) is an electrically motor-driven piston-cylinder system.

[Item 36] Braking system according to one of Items 1 to 35, characterized in that the at least one pressure supply (DV) is an electrically motor-driven rotary pump (RP).

[Item 37] Braking system according to one of 1 to 36, characterized in that one pressure supply serves as a redundant pressure supply and only serves as an auxiliary in the event of failure of the other pressure supply(ies) (DV, DV1, DV2), and/or to support the other pressure supply(ies) (DV, DV1, DV2), in particular to generate high pressures and/or to achieve higher dynamics of the braking system.

[Item 38] Braking system according to one of Items 1 to 37, characterized in that the pressure supply (DV) has a first and a second motor as drive, wherein the first motor is a brushless motor (ECE motor) with 2×3 phases and redundant control and the second motor is a 1-phase motor.

[Item 39] Braking system according to one of Items 1 to 38, characterized in that at least one pressure supply can be separated from the brake circuit(s) by a shut-off valve, in particular in the form of a switchable, in particular normally closed, solenoid valve.

[Item 40] Braking system according to one of Items 1 to 39, characterized in that the number of outlet valves (AV) per brake circuit (BK1, BK2) is different.

[Item 41] Braking system according to one of Items 1 to 40, characterized in that, in the event of a faulty outlet valve (AV), in particular in the event of an electronic/electrical fault in the outlet valve (AV), pressure reduction and pressure build-up in a wheel circuit takes place via the redundantly designed switching valve (SV) of the respective wheel circuit.

[Item 42] Diagnostic method for a braking system according to one of Items 1 to 41, characterized in that during driving and/or when the vehicle is stationary, the target brake pressure (p_{target}) is repeatedly compared with the actual brake pressure (p_{actual}), optionally also with their change over time (dt/dp), by at least one pressure sensor (DG) and, taking into account at least some other components of the braking system, such as the valves, the pressure supply, the master brake cylinder, the brake pedal, the E-pedal, and their control or switching state, and optionally vehicle parameters such as vehicle speed, vehicle deceleration, etc. a plausibility check is performed to monitor the function of the individual components of the braking system, and that if a fault is detected, the following measures are actively carried out by the braking system, either individually or in combination: a) the isolating valve (TV) is operated in pulse width modulation (PWM) mode in order to limit the volume flow through the valve; b) at least some of the drive windings of the drive motor of the pressure supply are short-circuited by a switching device so that the drive motor acts as a brake and thus reduces the piston speed of the pressure supply, thereby also the volume flow through the respective switching valve (SVᵢ₌₁₋₄) is limited and thereby preventing the switching valve (SVᵢ₌₁₋₄) from closing.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A braking system comprising:
at least two wheel brake cylinders, each of which is part of
separate wheel circuits;
at least one electrically driven pressure supply to build up pressure and reduce pressure in the at least two wheel brake cylinders;
at least one reservoir;
at least one electronic control and regulation device;
at least two switching valves; wherein
each of the at least two wheel brake cylinders is connected via a respective hydraulic connecting line to one of the at least two switching valves to disconnect and connect a hydraulic connection of the respective wheel brake cylinder and at least one other hydraulic main line, via the switching valve connectable at least to the pressure supply;
the at least two switching valves are normally open 2/2-way valves;
at least the hydraulic connecting line and the wheel one of the wheel circuits;
at least one of the at least two switching valves or all of the at least two switching valves have no check valve or no check valve is connected in parallel to the at least one switching valve;
in order to prevent one of the at least two switching valves from closing when the pressure is reduced via the one of the at least two switching valves, one or more of the following is included:
a) a valve actuator of the one of the at least two switching valves is force-loaded with a return force in an open position provided by a return spring and/or a magnetic force;
b) the pressure supply is configured to adjust or regulate a pressure reduction rate to close the one of the at least two switching valves;
c) the hydraulic connecting line connecting the pressure at least two switching valves includes a parallel circuit including a throttle and a check valve that blocks in a direction of the pressure supply;
d) a shut-off valve to connect or disconnect the wheel circuits from a master brake cylinder includes a flow cross-section configured to, when a pressure drop occurs in one of the wheel circuits, prevent the one of the at least two switching valves from sticking;
e) the shut-off valve is opened and closed in a pulse width mode in order to limit a flow rate or a flow velocity to a level such that tearing of the one of the at least two switching valves is prevented;
f) a drive of the pressure supply includes a multiphase electric motor including an electrical connection of windings configured such that, when a failure of a motor control and/or an electrical control device occurs, the electric motor is operated in a generator mode and a winding circuit of the electric motor acts as a brake for a piston of the pressure supply to limit or reduce a pressure reduction rate in the wheel circuits.

2. The braking system according to claim 1, wherein the at least two wheel brake cylinders are provided for a front axle;
electromechanical wheel brakes are provided for a rear axle;
the at least two wheel brake cylinders provided for the front axle are each part of their own wheel circuit.

3. The braking system according to claim 1, wherein
the master brake cylinder is a single master brake cylinder with only one hydraulic working chamber or a tandem master brake cylinder with two working chambers; and
the master brake cylinder is coupled to a brake pedal.

4. The braking system according to claim 3, wherein the brake pedal is an E-pedal.

5. The braking system according to claim 1, further comprising a circuit isolating valve that is closed when de-energized and is configured to selectively isolate or connect two brake circuits.

6. The braking system according to claim 2, wherein only the front axle has hydraulic brakes with a braking effect that is regulated or controlled by the pressure supply and electromechanical brakes are provided on the rear axle.

7. The braking system according to claim 1, wherein the pressure supply includes a double-acting piston and two working chambers connectable either to a brake circuit or to the at least one reservoir by two 3/2-way valves.

8. The braking system according to claim 1, wherein at least one of the at least two switching valves includes a redundant drive coil and/or a redundant control.

9. The braking system according to claim 1, wherein, in a functional state in which at least one of the wheel circuits has a functional fault that exceeds a certain fault severity threshold, pressure control is performed to either permanently close the switching valve assigned to the at least one of the wheel circuit at least temporarily, or permanently from a remainder of the braking system or others of the wheel circuits and/or the pressure supply and/or by an optional circuit isolating valve that is a normally closed valve; or
by at least one isolating valve, disconnects or connects at least two of the wheel circuits or brake circuits from or to each other.

10. The braking system according to claim 9, further comprising two brake circuits; wherein
at least one of the two brake circuits is assigned at least two of the wheel circuits; and
the two brake circuits are disconnectable or connectable from or to each other by the at least one circuit isolating valve.

11. The braking system according to claim 1, further comprising an electronic control and regulation device configured to perform a diagnosis of a leakage in one of the wheel circuits and determine whether the one of the wheel circuits is switched off by closing an associated one of the switching valves, or continues to be operated to generate a braking effect.

12. The braking system according to claim 1, wherein the braking system is configured to operate in a first basic operating state as long as no functional error exceeding a certain error threshold occurs in any of the wheel circuits.

13. The braking system according to claim 1, wherein
a) two of the wheel circuits are each assigned to one brake circuit;
b) three of the wheel circuits are each assigned to a first brake circuit and one of the wheel circuits is assigned to a second brake circuit; or
c) all of the wheel circuits are assigned to only one single brake circuit.

14. The braking system according to claim 1, wherein
each of the at least two wheel brake cylinders is connected via a respective hydraulic connecting line to one of the at least two switching valves configured to disconnect and connect a hydraulic connection of the respective wheel brake cylinder and at least one further hydraulic main line, via which one of the at least two switch valves is connectable or connected to at least to the pressure supply;
the hydraulic connecting line and the wheel brake cylinder connected thereto are components of one of the wheel circuits; and
an electronic control and regulation device is provided to perform a diagnosis of a leakage in one of the wheel circuits and determine whether the one of the wheel circuits is switched off by closing an associated one of the switching valves, or continues to be operated to generate a braking effect.

15. The braking system according to claim 1, wherein a degree of leakage or a leakage flow in one of the wheel circuits is determined using one or more of a) to e):
a) determination of a required amount of hydraulic fluid needed to achieve a target pressure in the respective wheel circuit in addition to a predetermined amount of the hydraulic fluid provided by the pressure supply;
b) determination of a calculated absolute pressure drop and/or a pressure drop gradient in the respective wheel circuit;
c) determination of a pressure deviation from a pressure value during pressure build-up in the respective wheel circuit by pumping a predetermined amount of fluid into the respective wheel circuit to achieve a target pressure and then determining an actual pressure;
d) diagnosis of a leakage in the wheel circuit via measurement of pressure over time measuring a pressure in the hydraulic line connecting one of the at least two switching valves and the pressure supply during the pressure build-up by the pressure supply or when the pressure supply is switched off;
e) measurement of an intake volume of the respective wheel circuit via the pressure supply to achieve a target pressure, and an absorption volume is determined by the pressure supply via current measurement of a drive motor of the pressure supply and/or a piston stroke of a piston of the pressure supply.

16. The braking system according to claim 15, wherein when an upper limit value or a limit value range of a leakage of the respective wheel circuit is exceeded, the respective associated switch valve is closed to prevent any braking action from occurring with the respective wheel brake cylinder, and below the upper limit value and above a lower limit value, an additional pressure is supplied to achieve the target brake pressure in the respective wheel brake cylinder.

17. The braking system according to claim 16, wherein when a leakage flow of 50% to 90% of a maximum delivery capacity of the pressure supply occurs, the leakage flow is compensated by the pressure supply by additional delivery of pressure.

18. The braking system according to claims 16, further comprising an electronic control and regulation device configured to determine whether and which of the wheel circuits that is leaking and to shut off the wheel circuits that is leaking by closing the respective switching valve.

19. The braking system according to claim 1, wherein when a fault in an outlet valve occurs, the switching valve of the respective wheel circuit, which is redundantly designed, is configured to perform pressure reduction and pressure build-up in the respective wheel circuit.

20. A diagnostic method for a braking system, the method comprising:
during driving and/or when a vehicle is stationary, a target brake pressure is repeatedly compared with an actual brake pressure by at least one pressure sensor;
performing a plausibility check to monitor a function of individual components of the braking system; and
upon detection of a fault, the braking system performs the following either individually or in combination:
a) operating an isolating valve in a pulse width modulation mode in order to limit a volume flow through the isolating valve;
b) at least some of drive windings of a drive motor of an electronically driven pressure supply are short-circuited by a switching device so that the drive motor acts as a brake to reduce a piston speed of the pressure supply to limit a volume flow through a switching valve and prevent the switching valve from closing.
